(19) United States
(12) Patent Application Publication
(10) Pub. No.: US 2016/0229334 A1
(43) Pub. Date: Aug. 11, 2016

(54) SIGNALING AND/OR LIGHTING DEVICE FOR A MOTOR VEHICLE HAVING A REMOVABLE HANDLING ELEMENT FOR A LIGHT BULB SUPPORT, AND PRODUCTION METHOD

(71) Applicant: VALEO ILUMINACION, Martos (ES)

(72) Inventors: Jean-Claude Puente, Livry Gargan (FR); Isidro Garcia, Jaen (ES); Jose Garcia Castilla, Martos (ES); Pedro Colmenero, Torredelcampo (ES)

(21) Appl. No.: 15/019,110

(22) Filed: Feb. 9, 2016

(30) Foreign Application Priority Data
Feb. 10, 2015 (FR) 1551048

(51) Int. Cl. B60Q 1/26; B60Q 1/34

(52) U.S. Cl. CPC B60Q 1/263; B60Q 1/34

(57) ABSTRACT

A signaling and/or lighting device for a motor vehicle comprises a casing provided with an opening for access toward the interior of the casing and a closure cover closing off the access opening. It also comprises a support for receiving a light bulb arranged in the casing and a removable handling element by means of which it is possible to manually actuate the support to install and remove it with respect to the casing. The device comprises holding elements for the removable handling element by means of which it is possible to reversibly attach the removable handling element to the casing or to the closure cover. A method for producing such a signaling and/or lighting device for a motor vehicle is also disclosed.

### CROSS-REFERENCE TO RELATED APPLICATIONS

This application claims priority to the French application 1551048 filed Feb. 10, 2015, which application is incorporated herein by reference and made a part hereof.

### BACKGROUND OF THE INVENTION

1. Field of the Invention

The invention relates to a signaling and/or lighting device for a motor vehicle, comprising a casing provided with an opening for access toward the interior of the casing, a closure cover closing off the access opening and a support for receiving a light bulb arranged in the casing.

The invention also relates to a method for producing such a signaling and/or lighting device for a motor vehicle.

2. Description of the Related Art

Conventionally, such a signaling and/or lighting device for a motor vehicle comprises a casing which is closed toward a front face by means of a protective outer lens designed to allow the passage of the light generated by the light bulb enclosed therein. At the rear face, the casing is provided with an access opening that is blocked by means of a closure cover which, when removed, allows access toward the interior of the housing and to the bulb.

The bulb may be designed for a high beam, low beam, position light, town light, turn indicator or hazard light function.

Currently, it is known to attach the bulb in question to the casing by means of a lamp carrier or a bulb-receiving support. This support is attached to the casing in a removable manner, for example via a bayonet system requiring the support to be moved by approximately a quarter-turn with respect to the casing. The bulb is also removably mounted on the support. The general arrangement of the assembly is generally such that the bulb faces the protective outer lens.

This solution has a principal drawback when the user wishes to change the bulb, for example out of necessity in the event of the bulb failing. The user must dismantle the support still bearing the lamp, withdraw this assembly in order to replace the bulb on the support, then re-fit, on the casing, the assembly consisting of the support and the new bulb. This operation requires the user to carry out a series of rotational and translational movements. This can prove difficult and troublesome if the support is not accessible for the user's hand. This problem increases with the new trend, for reasons of style, of placing the bulbs close to the protective outer lens, away from the region via which the bulbs are inserted into the casing; hitherto, it was usual to place the bulbs closer to the rear of the headlight and they were therefore more accessible.

Due to these difficulties, the user increasingly requires the services of a professional for replacing the bulb, with all the drawbacks that this involves in terms of service costs, immobilization of the vehicle, etc.

### SUMMARY OF THE INVENTION

The object of the present invention is to resolve the drawbacks of the prior art set out above.

One additional objective is to find a solution which is simple, economical, user-friendly, reliable and which has good flexibility between various types of bulbs and various types of motor vehicles.

To that end, the invention proposes a signaling and/or lighting device for a motor vehicle, comprising a casing provided with an opening for access toward the interior of the casing, a closure cover closing off the access opening, a support for receiving a light bulb arranged in the casing, and a removable handling element by means of which it is possible to manually actuate the support to install and remove it with respect to the casing, the device comprising holding elements for the removable handling element by means of which it is possible to reversibly attach the removable handling element to the casing or to the closure cover.

It may be done such that the removable handling element is arranged inside the casing when it is attached by means of the holding elements.

The removable handling element may comprise first coupling elements and the support may comprise second coupling elements complementary with the first coupling elements, the first and second coupling elements being able to mutually engage reversibly such that the signaling and/or lighting device varies selectively between a first configuration in which the removable handling element is attached by means of the holding elements and in which the first and second coupling elements do not mutually engage, and a second configuration in which the removable handling element is not attached to the device and is separated from the holding elements and in which the first and second coupling elements mutually engage so as to allow actuation of the support by the removable handling element for installation and removal of the former with respect to the casing.

The removable handling element may comprise a gripping region designed to be accessible from outside the casing when the second configuration is adopted.

The first and second coupling elements are preferably configured such that it is possible to transmit a torque from the removable handling element toward the support in order that the removable handling element being turned by the user turns the support with respect to the casing so as to install and remove it.

The holding elements preferably comprise snap-fitting elements borne by the casing and/or by the closure cover, the removable handling element being held by snap-fitting the removable handling element in the snap-fitting elements.

The holding elements may comprise a flexible connection element by means of which it is possible to permanently connect the removable handling element to the device, in particular to the closure cover, such that the removable handling element cannot be lost and cannot be separated from the casing or from the closure cover.

The removable handling element may comprise at least distinct first and second heads, the first head being configured such that it is possible to manually actuate a first type of support suitable for a first type of bulb, in particular a town light, to install and remove it with respect to the casing, and the second head being configured such that it is possible to manually actuate a second type of support, different from the first type of support, suitable for a second type of bulb, in particular a turn indicator bulb, to install and remove it with respect to the casing.

A method for producing such a signaling and/or lighting device for a motor vehicle may comprise a step of producing, in particular by casting, a single-piece part comprising the closure cover and the removable handling element connected to one another by a predetermined rupture region in order to make the region breakable and to allow the separation of the removable handling element with respect to the closure cover when a predetermined force is applied by the user to the removable handling element.

These and other objects and advantages of the invention will be apparent from the following description, the accompanying drawings and the appended claims.

### BRIEF DESCRIPTION OF THE ACCOMPANYING DRAWINGS

Other advantages and features will emerge more clearly from the following description of particular embodiments of the invention given by way of non-limiting examples and shown in the appended drawings, in which:

FIG. 1 is a cross section view of a first example of a device according to the invention;

FIG. 2 is a front perspective view of part of the device of FIG. 1;

FIG. 3 is a schematic cross section view of a second example of a device according to the invention;

FIG. 4 is a schematic cross section view of a third example of a device according to the invention;

FIG. 5 is a view of the closure cover when the removable handling element is held; and

FIG. 6 is a perspective view showing the closure cover and the removable handling element when it is not held.

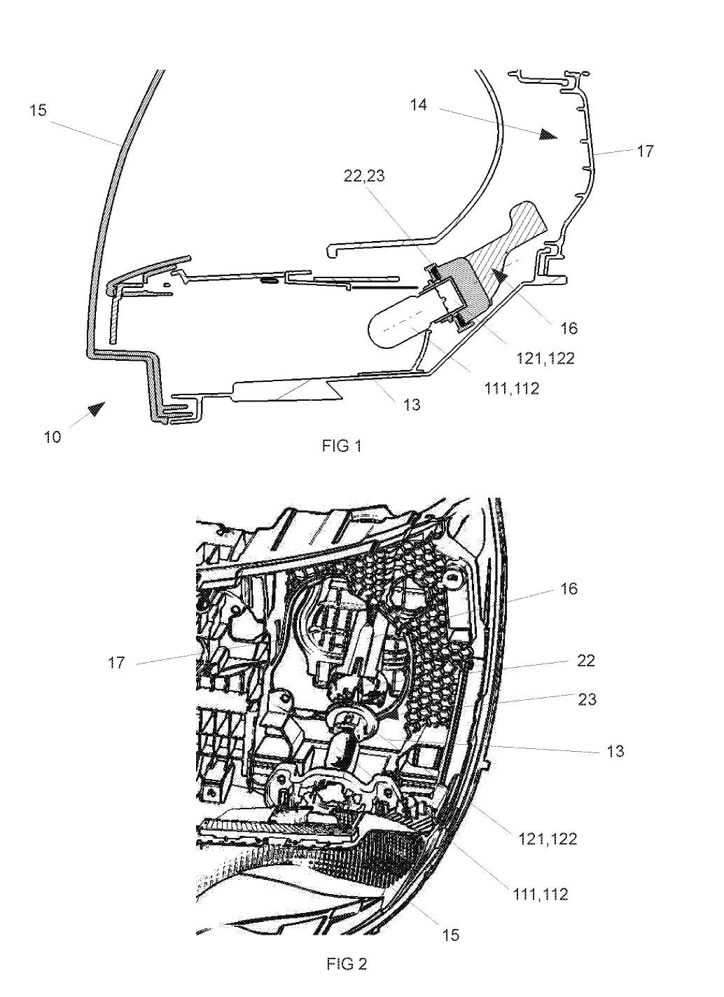

### DETAILED DESCRIPTION OF THE PREFERRED EMBODIMENTS

The invention will be described in the particular case of a signaling and/or lighting device 10 for a motor vehicle located at the front of the vehicle and constituting what is conventionally called a headlight. These features are not limiting with respect to the extent of the possible field of application of the invention presented herein below.

The signaling and/or lighting device 10 comprises a casing 13 provided with an opening 14 for access toward the interior of the casing 13. The signaling and/or lighting device 10 is understood as an optical device, the function of which is to emit light through a transparent or translucent wall of the casing 13, for the purpose of signaling and/or lighting within the context of use for a motor vehicle.

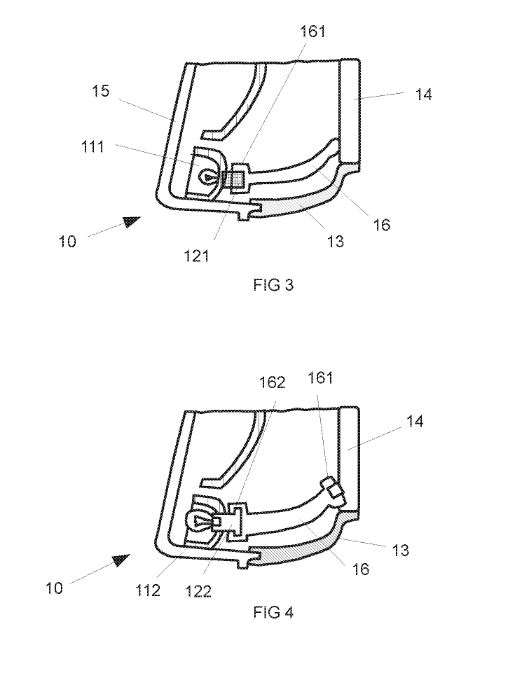

The casing 13 encloses and protects a light bulb which, in the figures, is labeled with the references 111, 112. In the relevant technical field, such a light bulb 111, 112 is also known as a “lamp”. Depending on the nature of the signaling and/or lighting device 10 and on its function within the vehicle, the light bulb may correspond to a lamp 111, the function of which is to act as a town light for example (as in the example of FIG. 3), or a lamp 112, the function of which is to form a lamp of a turn indicator or hazard light for example (as in the example of FIG. 4). It might also be a bulb used in the context of a traffic light or a pedestrian crossing light for example.

The signaling and/or lighting device 10 comprises a support for receiving a light bulb 111, 112, labeled with references 121, 122 in the figures. The support 121, 122 is arranged in the casing 13. In the technical field of interest here, such a support 121, 122 is also known as a “lamp carrier”. Its structure is generally suited to the nature of the bulb 111, 112 which it is designed to bear and to supply with electricity. The bulb 111, 112 is reversibly mounted on the corresponding support 121, 122, in the same way that the support 121, 122 is itself removably mounted with respect to the casing 13 such that it is possible to move, with respect to the casing 13, the assembly consisting of the support 121, 122 and the bulb 111, 112 when changing the bulb 111, 112. By way of example having the advantage of simplicity, the support 121, 122 is removably attached to the casing 13 by means of a bayonet system requiring the support 121, 122 to be turned by approximately a quarter-turn with respect to the casing 13.

In particular, FIG. 3 shows a first type of support, referenced 121, suitable for a first type of bulb, that is to say the bulb which is referenced 111 and which is in particular a town light. The first type of support 121 can be mounted and removed with respect to the casing 13. In addition, FIG. 4 shows a second type of support, referenced 122, which is different from the first type of support 121 and is suitable for a second type of bulb, that is to say the bulb referenced 112 which is in particular a turn indicator bulb. The second type of support 122 is also able to be mounted and removed with respect to the casing 13.

The casing 13 is closed toward the front by a protective outer lens 15 designed to allow the light generated by the light bulb 111, 112 enclosed therein to pass through. The rear face of the casing 13 is closed off, at the level of the opening 14, by means of a closure cover 17. This may be removably attached by any suitable means. Removing this closure cover 17 allows access toward the interior of the casing 13 and in particular to the bulb 111, 112, or at least to the support 121, 122.

The signaling and/or lighting device 10 also comprises a removable handling element 16 by means of which it is possible to manually actuate, remotely, the support 121, 122 to install and remove it with respect to the casing 13. In other words, the removable handling element 16, which for example is in the general shape of a stem, is a tool by means of which it is possible to be manually gripped by the user at a first end of the tool and engage at a second end of the tool with the support 121, 122 to be mounted and to be removed. The movements applied to the removable handling element 16 by the user at the first end of the removable handling element 16 cause actuation of the support 121, 122 by the second end of the removable handling element 16, in order to mount and remove the support 121, 122 by means of the removable handling element 16. The removable handling element 16 may be considered as an extension permitting remote, manual handling of the support 121, 122 by the user, in the event that the latter cannot grip it manually, in particular if access through the opening 14 is difficult or impossible.

The signaling and/or lighting device 10 comprises holding elements 20 for holding the removable handling element 16, which holding elements 20 are configured such that it is possible to reversibly and therefore removably attach the removable handling element 16 to the casing 13 or to the closure cover 17.

According to the embodiment as illustrated, but in no way limiting, the removable handling element 16 is arranged inside the casing 13 when it is attached by means of the holding elements 20. This makes it possible to protect the removable handling element 16 and, as far as possible, avoid it being lost when not in use. However, it remains possible to provide that the removable handling element 16 is arranged outside the casing 13 when it is attached by means of the holding elements 20. The holding elements 20 will then be suitably adapted.

The removable handling element 16 comprises first coupling elements 22 and the support 121, 122 comprises second coupling elements 23 complementary with the first coupling elements 22. The first and second coupling elements 22, 23 are able to mutually engage reversibly such that the signaling and/or lighting device 10 varies selectively between:
a first configuration in which the removable handling element 16 is attached by means of the holding elements 20 and in which the first and second coupling elements 22, 23 do not mutually engage,
and a second configuration in which the removable handling element 16 is not attached and is separated from the holding elements 20 and in which the first and second coupling elements 22, 23 mutually engage so as to allow actuation of the support 121, 122 by the removable handling element 16 for installation and removal of the former with respect to the casing 13.

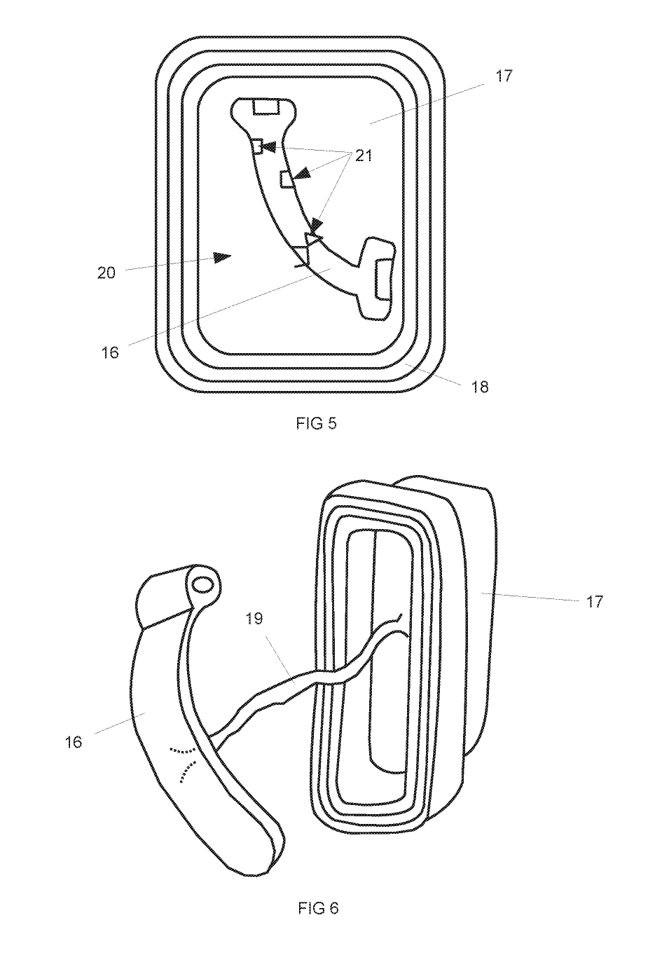

FIG. 5 shows the first configuration whereas FIGS. 3 and 4 show the second configuration.

The nature of the first and second coupling elements 22, 23 is not limiting per se. They may for example be of male and female type as shown in FIG. 1, suitable for transmitting a torque when they mutually engage, from the element 16 toward the support 121, 122.

The second configuration corresponds to a state of the signaling and/or lighting device 10 in which the removable handling element 16 and the bulb support are able to move relative to one another.

The removable handling element 16 comprises a gripping region designed to be accessible from outside the casing 13 when the second configuration is adopted. Such an arrangement facilitates manipulation of the removable handling element 16 by the user when mounting and removing the support 121, 122 on the casing 13.

According to one particular embodiment, the first and second coupling elements 22, 23 are configured such that it is possible to transmit a torque from the removable handling element 16 toward the support 121, 122 in order that the removable handling element 16 being turned by the user turns the support 121, 122 with respect to the casing 13 so as to install and remove it.

With reference now to FIG. 5, the holding elements 20 comprise snap-fitting elements 21 borne by the casing 13 and/or by the closure cover 17. The removable handling element 16 is held by snap-fitting the removable handling element 16 in the snap-fitting elements 21. The example of FIG. 5 shows a particular arrangement in which the snap-fitting elements 21 are arranged on an internal face of the closure cover 17, by means of which it is possible to place the handling element 16 inside the casing 13 when, on one hand, the handling element 16 is attached to the closure cover 17 via the snap-fitting elements 21 and, on the other hand, the closure cover 17 is attached so as to close off the opening 14. Another advantage of this arrangement is to make the handling element 16 appear to the user when he removes the closure cover 17, which will encourage them to use it. The reversible attachment between the closure cover 17 and the casing 13 may be achieved by any means. A seal, referenced 18, arranged at the periphery of the closure cover 17 and secured thereto, may be interposed between the closure cover 17 and the casing 13 around the opening 14 so as to seal against water and air.

The snap-fitting elements 21 may alternatively be formed on an outer face of the closure cover 17 so as to hold the handling element 16 outside the casing 13 or on an inner or outer face of the casing 13.

The holding elements 20 preferably comprise a flexible connection element 19 by means of which it is possible to permanently connect the removable handling element 16 to the signaling and/or lighting device 10, in particular to the closure cover 17, such that the removable handling element 16 cannot be lost and cannot be separated from the casing 13 or from the closure cover 17. In particular, the objective is to connect the handling element 16 to either the casing 13 or the closure cover 17 when the second configuration defined hereinabove is adopted. FIG. 6 shows the particular case in which the flexible connection element 19, which is for example a cord, a wire, a cable or the like, permanently connects the removable handling element 16 to the closure cover 17, even when the removable handling element 16 is not attached by the holding elements 20.

In the example shown in FIG. 4, which is very advantageous in terms of flexibility and modularity of use between various types of motor vehicles and various types of bulbs, the removable handling element 16 has a two- or three-headed arrangement: it comprises at least first and second heads 161, 162 which are distinct from one another, in particular arranged at opposite ends of the handling element 16. The first head 161 is configured such that it is possible to manually actuate the first type of support 121 suitable for the first type of bulb 111, to install and remove it with respect to the casing 13. The second head 162, for its part, is configured such that it is possible to manually actuate the second type of support 122 suitable for the second type of bulb 112, to install and remove it with respect to the casing 13. One alternative, which is not shown, provides arranging the removable handling element 16 having three heads which are distinct and are respectively suitable for the cooperation with three types of supports for bulbs which are different from one another.

Each head 161, 162 may have, integrated therein, the second coupling elements 23 mentioned above, suitable for cooperation with the associated first coupling elements 22 borne by the corresponding support 121, 122.

It is to be noted, however, as in FIG. 1 and FIG. 3, that the removable handling element 16 may be equipped with only one head suitable for a single type of bulb support 121, 122.

During fabrication of such a signaling and/or lighting device 10 for a motor vehicle, it may be advantageous to implement a step of producing, in particular by casting, a single-piece part comprising the closure cover 17 and the removable handling element 16 connected to one another by a predetermined rupture region. This arrangement makes it possible to make this predetermined rupture zone breakable and to allow the separation of the removable handling element 16 with respect to the closure cover 17 when a predetermined force is applied by the user to the removable handling element 16. But, before this force is applied, the removable handling element 16 is then rigidly secured to the closure cover 17, which makes it possible to avoid any risk of loss of the removable handling element 16 until it is necessary to change a bulb 111, 112.

It goes without saying that the figures are provided solely by way of illustration and that each of the parts making up the signaling and/or lighting device 10 described above may have other forms and other dimensions.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A signaling and/or lighting device for a motor vehicle, comprising a casing provided with an opening for access toward an interior of said casing, a closure cover closing off said opening, a support for receiving a light bulb arranged in said casing, and a removable handling element by means of which it is possible to manually actuate said support to install and remove it with respect to said casing, said signaling and/or lighting device comprising holding elements for said removable handling element by means of which it is possible to reversibly attach said removable handling element to said casing or to said closure cover.

2. The signaling and/or lighting device according to claim 1, wherein said removable handling element is arranged inside said casing when it is attached by means of said holding elements.

3. The signaling and/or lighting device according to claim 1, wherein said removable handling element comprises first coupling elements and said support comprises second coupling elements complementary with said first coupling elements, said first coupling element and said second coupling element being able to mutually engage reversibly such that said signaling and/or lighting device varies selectively between a first configuration in which said removable handling element is attached by means of said holding elements and in which said first coupling element and said second coupling element do not mutually engage, and a second configuration in which said removable handling element is not attached to said signaling and/or lighting device and is separated from said holding elements and in which said first coupling element and said second coupling element mutually engage so as to allow actuation of said support by said removable handling element for installation and removal of the former with respect to said casing.

4. The signaling and/or lighting device according to claim 3, wherein said removable handling element comprises a gripping region designed to be accessible from outside said casing when said second configuration is adopted.

5. The signaling and/or lighting device according to claim 3, wherein said first coupling element and said second coupling element are configured such that it is possible to transmit a torque from said removable handling element toward said support in order that said removable handling element being turned by the user turns said support with respect to said casing so as to install and remove it.

6. The signaling and/or lighting device according to claim 1, wherein said holding elements comprise snap-fitting elements borne by said casing and/or by said closure cover, said removable handling element being held by snap-fitting said removable handling element in said snap-fitting elements.

7. The signaling and/or lighting device according to claim 1, wherein said holding elements comprise a flexible connection element by means of which it is possible to permanently connect said removable handling element to said signaling and/or lighting device in particular to said closure cover, such that said removable handling element cannot be lost and cannot be separated from said casing or from said closure cover.

8. The signaling and/or lighting device according to claim 1, wherein said removable handling element comprises at least distinct first and second heads said first head being configured such that it is possible to manually actuate a first type of support suitable for a first type of bulb, in particular a town light, to install and remove it with respect to said casing, and said second head being configured such that it is possible to manually actuate a second type of support, different from said first type of support, suitable for a second type of bulb, in particular a turn indicator bulb, to install and remove it with respect to said casing.

9. A method for producing a signaling and/or lighting device for a motor vehicle according to claim 1, comprising a step of producing, in particular by casting, a single-piece part comprising said closure cover and said removable handling element connected to one another by a predetermined rupture region in order to make said region breakable and to allow the separation of said removable handling element with respect to said closure cover when a predetermined force is applied by the user to said removable handling element.

10. The signaling and/or lighting device according to claim 2, wherein said removable handling element comprises first coupling elements and said support comprises second coupling elements complementary with said first coupling elements, said first coupling element and said second coupling element being able to mutually engage reversibly such that said signaling and/or lighting device varies selectively between a first configuration in which said removable handling element is attached by means of said holding elements and in which said first coupling element and said second coupling element do not mutually engage, and a second configuration in which said removable handling element is not attached to said signaling and/or lighting device and is separated from said holding elements and in which said first coupling element and said second coupling element mutually engage so as to allow actuation of said support by said removable handling element for installation and removal of the former with respect to said casing.

11. The signaling and/or lighting device according to claim 4, wherein said first coupling element and said second coupling element are configured such that it is possible to transmit a torque from said removable handling element toward said support in order that said removable handling element being turned by the user turns said support with respect to said casing so as to install and remove it.

12. The signaling and/or lighting device according to claim 2, wherein said holding elements comprise snap-fitting elements borne by said casing and/or by said closure cover, said removable handling element being held by snap-fitting said removable handling element in said snap-fitting elements.

13. The signaling and/or lighting device according to claim 3, wherein said holding elements comprise snap-fitting elements borne by said casing and/or by said closure cover, said removable handling element being held by snap-fitting said removable handling element in said snap-fitting elements.

14. The signaling and/or lighting device according to claim 4, wherein said holding elements comprise snap-fitting elements borne by said casing and/or by said closure cover, said removable handling element being held by snap-fitting said removable handling element in said snap-fitting elements.

15. The signaling and/or lighting device according to claim 2, wherein said holding elements comprise a flexible connection element by means of which it is possible to permanently connect said removable handling element to said signaling and/or lighting device, in particular to said closure cover, such that said removable handling element cannot be lost and cannot be separated from said casing or from said closure cover.

16. The signaling and/or lighting device according to claim 3, wherein said holding elements comprise a flexible connection element by means of which it is possible to permanently connect said removable handling element to said signaling and/or lighting device, in particular to said closure cover, such that said removable handling element cannot be lost and cannot be separated from said casing or from said closure cover.

17. The signaling and/or lighting device according to claim 4, wherein said holding elements comprise a flexible connection element by means of which it is possible to permanently connect said removable handling element to said signaling and/or lighting device, in particular to said closure cover, such that said removable handling element cannot be lost and cannot be separated from said casing or from said closure cover.

18. The signaling and/or lighting device according to claim 2, wherein said removable handling element comprises at least distinct first and second heads, said first head being configured such that it is possible to manually actuate a first type of support suitable for a first type of bulb, in particular a town light, to install and remove it with respect to said casing, and said second head being configured such that it is possible to manually actuate a second type of support, different from said first type of support, suitable for a second type of bulb, in particular a turn indicator bulb, to install and remove it with respect to said casing.

19. The signaling and/or lighting device according to claim 3, wherein said removable handling element comprises at least distinct first and second heads, said first head being configured such that it is possible to manually actuate a first type of support suitable for a first type of bulb, in particular a town light, to install and remove it with respect to said casing, and said second head being configured such that it is possible to manually actuate a second type of support, different from said first type of support, suitable for a second type of bulb, in particular a turn indicator bulb, to install and remove it with respect to said casing.

20. The signaling and/or lighting device according to claim 4, wherein said removable handling element comprises at least distinct first and second heads, said first head being configured such that it is possible to manually actuate a first type of support suitable for a first type of bulb, in particular a town light, to install and remove it with respect to said casing, and said second head being configured such that it is possible to manually actuate a second type of support, different from said first type of support, suitable for a second type of bulb, in particular a turn indicator bulb, to install and remove it with respect to said casing.
